(19) United States
(12) Patent Application Publication
(10) Pub. No.: US 2007/0252376 A1
(43) Pub. Date: Nov. 1, 2007

(54) Vehicle-shaped book of foam-based pages

(76) Inventor: Christian Legrand, Nonthaburi (TH)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/524,118

(22) Filed: Sep. 20, 2006

(30) Foreign Application Priority Data
Mar. 24, 2006 (FR) 06/02595

(51) Int. Cl. B42D 1/00

(52) U.S. Cl. 281/15.1

(57) ABSTRACT

A vehicle-shaped book of foam-based pages includes a center chassis page and at least one body page, each page being constructed of a panel of a semi-flexible foam material. The center chassis page and the body pages are bound to adjacent pages thereof in a book format. Front and rear ground-engaging wheels are rotatably mounted on the center chassis page whereby the vehicle-shaped book is rollable on the front and rear ground-engaging wheels.

### CROSS-REFERENCE TO RELATED FOREIGN PATENT

This application claims priority based on a foreign patent, specifically on the French Patent Application Serial No. 06/02595 filed Mar. 24, 2006.

### BACKGROUND OF THE INVENTION

1. Technical Field

The present invention is directed to books having foam-based pages and, more particularly, to a vehicle-shaped book of foam-based pages which includes a center chassis page and at least one body page, each page including a middle foam plate and front and back semi-rigid paper plates mounted on and sandwiching the middle foam plate, the center chassis page and body pages bound to adjacent pages thereof in a book format, a lower chassis body on which is mounted the center chassis page and front and rear ground-engaging wheels rotatably mounted on the lower chassis body whereby the vehicle-shaped book is rollable on the front and rear ground-engaging wheels.

2. Description of the Prior Art

There are many different kinds of books and book bindings which are currently used in the publishing industry. While the majority of books are constructed of paper and paper products, there are many different types of children's books which are constructed of different materials such as cloth, foam, or other such materials, in order to provide additional tactile sensations for the children reading the books. Recently, one of the more popular types of manufacturing materials used in connection with children's books are thin plates of foam which constitute the pages and front and rear covers of the children's books. These are bound together in many different ways and assembled to form many different shapes and sizes of children's books, but in general, these function only as books and not as toys which can be played with. Of course, this is not a disadvantage when there is no intent to use the books as toys, but it would significantly add to the enjoyment of the book if it could also be used as a toy and not just as a book.

One of the most popular subjects for children's books involve vehicles of many different sizes and shapes. For example, books about the many different types of trucks are very popular with boys and girls of ages two to ten, and this is why there are numerous children's books on this subject. However, it is also true that the level of excitement and interest generated by such books is limited in that the child cannot physically experience what it is like when a vehicle is in motion. To experience this, the child must play with various kinds of vehicular toys which replicate the much-larger versions which travel on our streets and highways. It is believed, however, that it would be truly exciting and interesting for a child if he or she were not only able to read about various types of vehicles in a book, but also play with the book as a toy which replicates at least one of the vehicles which are displayed within the book. There is therefore a need for such a vehicle-shaped book which also functions as a toy.

Therefore, an object of the present invention is to provide a vehicle-shaped book made of foam pages which includes wheels to allow the book to function both as a book and a toy.

Another object of the present invention is to provide a vehicle-shaped book of foam-based pages which includes a center chassis page and at least one body page, each page including a middle foam plate and front and back semi-rigid paper plates mounted on and sandwiching the middle foam plate, the center chassis page and body pages bound to adjacent pages thereof in a book format, a lower chassis body on which is mounted the center chassis page and front and rear ground-engaging wheels rotatably mounted on the lower chassis body whereby the vehicle-shaped book is rollable on the front and rear ground-engaging wheels.

Another object of the present invention is to provide a vehicle-shaped book of foam-based pages which visually resembles a selected vehicle such as a truck, car, airplane, or other such vehicle so that the child playing with the book may both learn about the vehicles displayed within the book and also play with the vehicle thereby increasing their enjoyment and interest in the vehicle-shaped book.

Another object of the present invention is to provide a vehicle-shaped book of foam-based pages which includes two front wheels and two rear wheels, with the rear wheels being powered by a mechanical or electric motor device to drive the vehicle-shaped book forwards.

Finally, an object of the present invention is to provide a vehicle-shaped book of foam-based pages which is relatively simple and economical to manufacture and which is safe, effective, and efficient in use.

### SUMMARY OF THE INVENTION

The present invention provides a vehicle-shaped book of foam-based pages which includes a center chassis page and at least one body page, each page including a middle foam plate and front and back semi-rigid paper plates mounted on and sandwiching the middle foam plate. The center chassis page and the body pages are bound to adjacent pages thereof in a book format. A lower chassis body is included on which the center chassis page is mounted and extends upwards therefrom. Finally, front and rear ground-engaging wheels are rotatably mounted on the lower chassis body whereby the vehicle-shaped book is rollable on the front and rear ground-engaging wheels.

The present invention thus provides a substantial improvement over those books currently being manufactured and sold for use by children. For example, because the foam-based pages are safe and soft, it is unlikely that children playing with the present invention will be injured through contact with the invention. Furthermore, because the present invention not only can be used as a book but also can be played with by the child as a toy, it is far more likely that the child's interest will be maintained for a greater period of time than with those single use books and toys found in the prior art. Finally, it is believed that the combination of the book and toy features of the present invention will make reading and learning more enjoyable for the child, which is clearly the goal of educational toys and books. It is therefore seen that the vehicle-shaped book of the present invention provides a substantial improvement over those books found in the prior art.

### BRIEF DESCRIPTION OF THE DRAWINGS

FIG. 1 is a perspective view of the vehicle-shaped book of the present invention;

FIG. 2 is a side elevational view of the book;

FIG. 3 is a front elevational view of the book;

FIG. 4 is a perspective view of the book showing the pages and central chassis page thereof; and

FIG. 5 is a top plan view of the book showing the pages and central chassis page thereof and the mounting of the wheels on the lower chassis body.

### DESCRIPTION OF THE PREFERRED EMBODIMENT

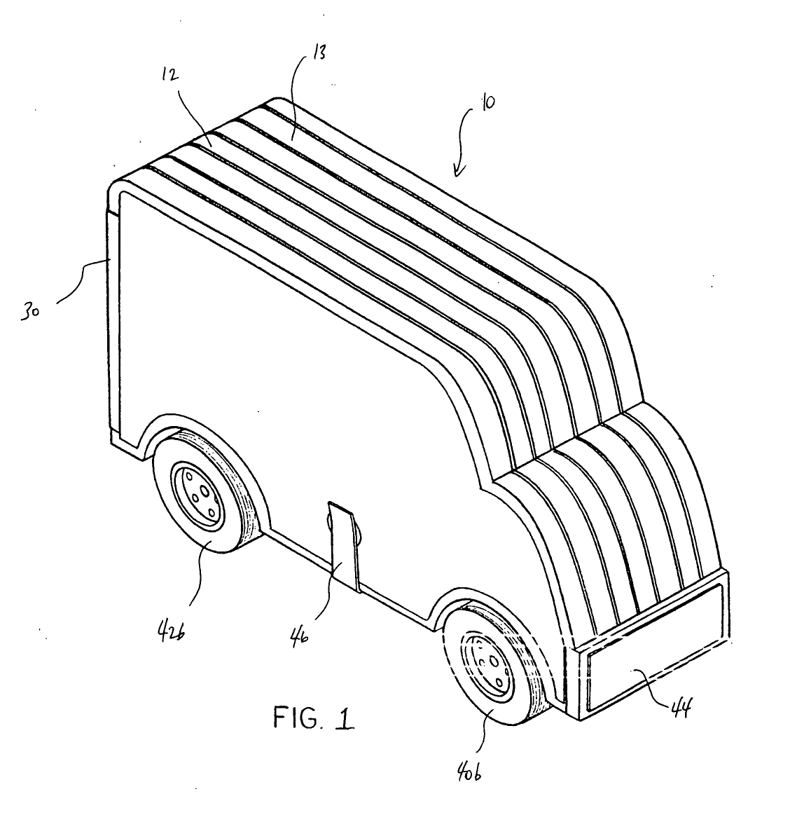

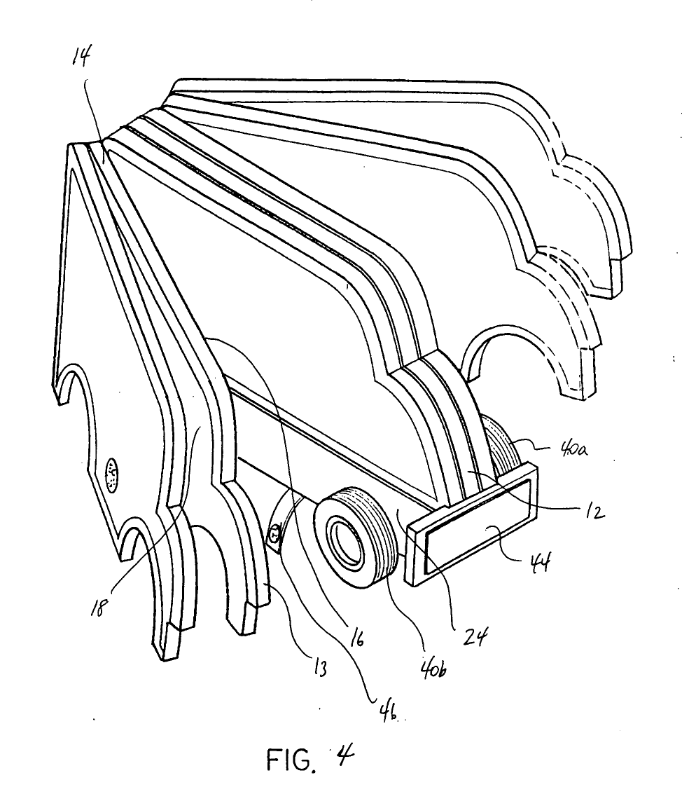

The vehicle-shaped book 10 of the present invention is shown best in FIGS. 1-5 as including a center chassis page 12 and a plurality of body pages 13, each of which would be constructed of a foam material in substantially the same manner. Specifically, each of the pages 12 and 13 would include a middle foam plate 14 and front and back semi-rigid paper plates 16 and 18, the front and back paper plates 16 and 18 secured to the middle foam plate 14 by an adhesive material or the like to ensure that the front and back paper plates 16 and 18 remain attached to the middle foam plate 14. In the preferred embodiment the middle foam plate 14 would preferably be constructed of a foam material, specifically the foam marketed under the common name “Eva Foam,” which is a polymer foam made of ethyl-vinyl acetate and which is non-toxic and resilient to tearing, and thus is quite safe for use with children. One of the advantages of Eva Foam is that it is pliable and thus is safe for use by children, but in the present invention, however, it is preferable to combine the foam plate with material more conducive for printing indicia and pictures thereon, and it is for this reason that the front and back paper plates 16 and 18 are mounted on the middle foam plate 14.

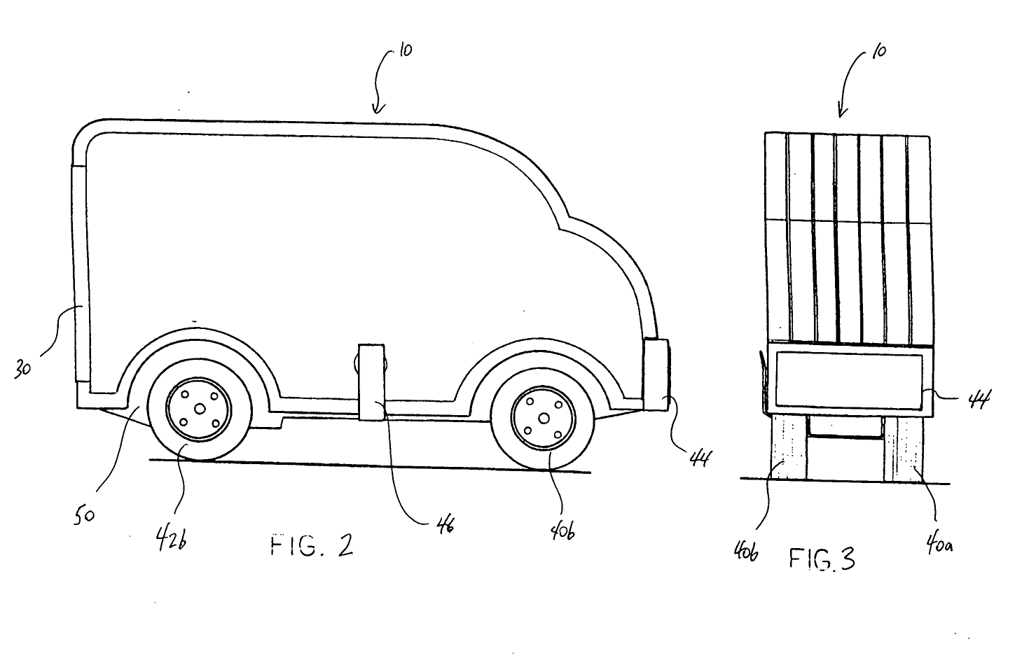

In the preferred embodiment, the front and back paper plates 16 and 18 would be constructed of a semi-rigid paper material such as cardstock or the like which would readily receive printed indicia thereon for printing of the book pages, and will also provide additional rigidity for the middle foam plate 14. Furthermore, it is important that the front and back paper plates 16 and 18 have dimensions slightly smaller than the middle foam plate 14 such that the middle foam plate 14 extends beyond the edges of the front and back paper plates 16 and 18, as shown best in FIGS. 1 and 2, thus ensuring that the edges of the pages 12 are foam, thus preventing paper cuts or other injuries to children using the present invention. A final important consideration for the pages 12 is that they may be constructed of virtually any size, shape, and thickness via die cut or other cutting method, which means that the vehicle-shaped book 10 may be constructed to replicate the shape of almost any vehicle, thereby greatly increasing the potential audience for the present invention. Therefore, the particular vehicle shape shown in FIGS. 1-5 should be understood to be only illustrative of the types of vehicles which may be replicated by the present invention, which are only limited by the economic, manufacturing, and purchasing restrictions set by the manufacturer and the marketplace.

In the preferred embodiment, the central chassis page 12 and plurality of body pages 13 would each be of approximately the same shape on the top and rear surfaces, specifically that the pages are shaped like a vehicle, such as a truck, automobile, or other such vehicle. In the embodiment shown in FIGS. 1-5, the vehicle-shaped book 10 is of a standard truck configuration, although it should be noted, as was stated previously, that many different sizes and shapes of vehicles may be represented by the vehicle-shaped book 10 of the present invention merely by cutting the central chassis page 12 and body pages 13 to the appropriate shape.

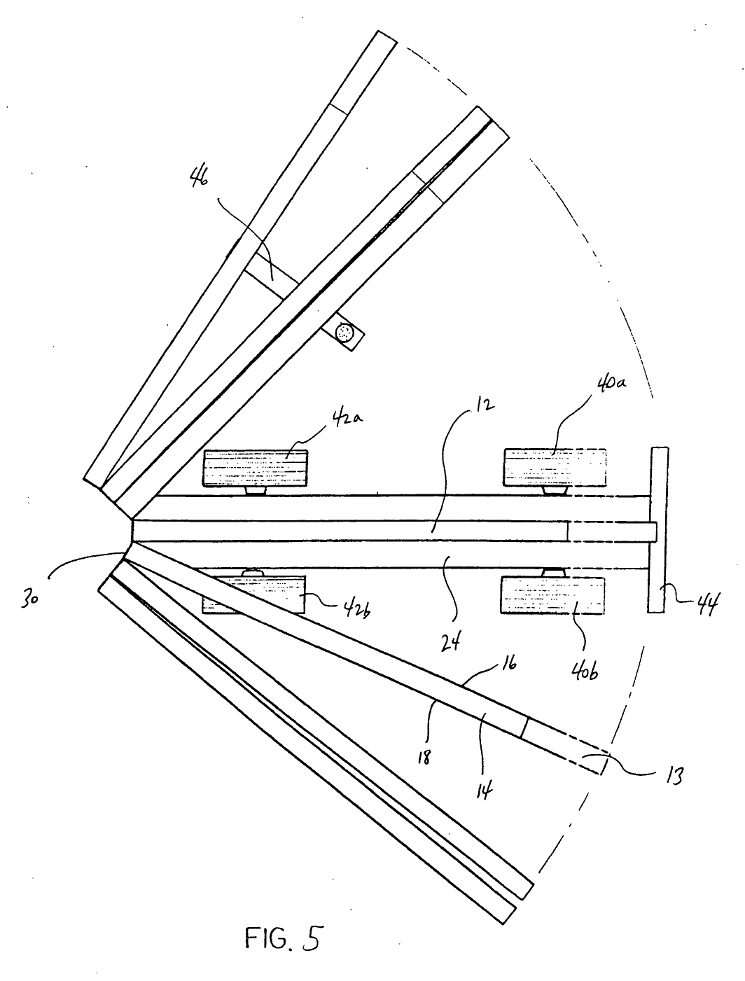

A binder 30 extends across and connects the rear edges of the central chassis page 12 and each of the body pages 13, as shown best in FIGS. 1 and 5, and in the preferred embodiment, the binder 30 would be a reinforced paper sheet which is connected to the pages by an adhesive such as glue or the like. Of course, other types of binders may be used in connection with the vehicle-shaped book 10 of the present invention so long as the central chassis page 12 and body pages 13 are secured in a book format as shown in FIGS. 1-5 and the pages are free to be opened from their closed position shown best in FIG. 1 to the open position shown in FIGS. 4 and 5.

The key structural feature of the present invention, however, is clearly the lower chassis body 24 on which is mounted central chassis page 12 which extends generally perpendicularly upwards from the lower chassis body 24. The lower chassis body 24 would preferably be constructed as a molded plastic generally rectangular box, although the precise construction material used in connection with the lower chassis body 24 is not critical so long as the lower chassis body 24 provides a stable, sturdy mounting chassis body for the central chassis page 12.

Rotatably mounted on opposite sides of lower chassis body 24 are front wheels 40a and 40b and rear wheels 42a and 42b which, in the preferred embodiment, would be small plastic or rubber wheels which are mounted on axles extending through the lower chassis body 24 or mounted beneath lower chassis body 24 as the manufacturer may see fit. As shown in FIG. 1, the front and rear wheels 40a and 40b and 42a and 42b permit the vehicle-shaped book 10 of the present invention to be rolled forward or backwards for use as a toy truck or other such toy vehicle, a feature which is not found in the prior art. This means that not only can the user of the present invention peruse the contents printed on the body pages 13 and central chassis page 12, but here he or she may also play with the vehicle-shaped book 10 by rolling the book 10 over a ground surface via front and rear wheels 40a, 40b, 42a and 42b. Clearly, this will significantly increase the enjoyment and excitement in reading and playing with the vehicle-shaped book 10 of the present invention, and it is believed that this increase in enjoyment will likely lead to an increased interest in reading.

In an alternative embodiment, the rear wheels 42a and 42b would be connected to a mechanical or electric motor device 50 which would be mounted within the lower chassis body 24 or directly underneath the lower chassis body 24, the motor 50 operative to propel the vehicle-shaped book 10 forward over a ground surface. Numerous different types of motors 50 may be used in connection with the present invention, although it has been found that a simple mechanical motor using a flywheel, coil spring or the like would provide sufficient power to propel the vehicle-shaped book 10 of the present invention.

The vehicle-shaped book 10 of the present invention as shown in FIGS. 1-5 may also include additional elements such as the front bumper 44 which is mounted on the lower chassis body 24 and also the page securement strap 46 which extends between and releasably connects the outer body pages 13 as shown best in FIGS. 1, 4 and 5. In the preferred embodiment, the page securement strap 46 would be a fabric strap which is affixed to one of the outer body pages 13 and is releasably connected via hook-and-loop fasteners to the opposite outer body page 13 to releasably secure the vehicle-shaped book 10 in its closed position as shown best in FIG. 1. Of course, many different types of securement devices may be used in connection with the present invention to secure the pages in closed position, any of which may be substituted for the page securement strap 46 described herein.

Finally, it should be noted that because the central chassis page 12 and body pages 13 each include front and rear paper plates 16 and 18, as shown in FIGS. 4 and 5, it is a relatively simple matter to print virtually any kind of pictures, words, or other indicia on the central chassis page 12 and body pages 13 which will be shown in the vehicle-shaped book 10. Also, it should be noted that the same holds true if the central chassis page 12 and body pages 13 are constructed of just the foam material and do not include the front or rear paper plates 16 and 18, as the foam material may be printed on by many different commercial printing methods, any of which would be understood by one skilled in the art of printing on alternative page construction materials. The important consideration, however, is that the vehicle-shaped book 10 may be constructed in many different sizes and shapes, and the printed materials which are printed on central chassis page 12 and body pages 13 may tie into and enhance the selected shape of the vehicle-shaped book 10.

It is to be understood that numerous additions, substitutions and modifications may be made to the vehicle-shaped book 10 of the present invention which fall within the intended broad scope of the appended claims. For example, the central chassis page 12 and body pages 13 may be constructed of various types of foam materials, both including front and rear paper plates 16 and 18, or not including the paper plates, and such modifications and changes should be understood to be a part of this disclosure. Furthermore, the specific number of wheels used in connection with the present invention may be modified or changed if the vehicle intended to be replicated includes more or fewer wheels than described previously. For example, should the present invention be used to replicate a tractor-trailer truck, the vehicle-shaped book 10 could potentially include up to eighteen wheels to properly replicate the tractor-trailer truck. Likewise, if the vehicle-shaped book 10 of the present invention were constructed to replicate a motorcycle or the like, the book would have only two wheels mounted thereon, and the appropriate connections and mountings for the selected number of wheels on the lower chassis body 24 would be understood by one skilled in the art of toy vehicle manufacturing. Finally, it should be noted that the size, shape and colors used in connection with the vehicle-shaped book 10 of the present invention may be modified or changed depending on the intended audience for the vehicle-shaped book 10, and such modifications should be understood to be a part of this disclosure.

There has therefore been shown and described a vehicle-shaped book 10 of foam-based pages which accomplishes at least all of its intended objectives.

I claim:

1. A vehicle-shaped book of foam-based pages comprising:
a center chassis page and at least one body page, each page being constructed of a panel of a semi-flexible foam material;
said center chassis page and said at least one body page bound to adjacent pages thereof in a book format;
a lower chassis body on which said center chassis page is mounted on and extends upwards therefrom; and
front and rear ground-engaging wheels rotatably mounted on said center chassis page whereby said vehicle-shaped book is rollable on said front and rear ground-engaging wheels.

2. The vehicle-shaped book of foam-based pages of claim 1 wherein said center chassis page and at least one body page each are constructed as including a middle foam plate and front and back semi-rigid paper plates mounted on and sandwiching said middle foam plate.

3. The vehicle-shaped book of foam-based pages of claim 2 wherein said middle foam plate is larger than said front and back semi-rigid paper plates such that said middle foam plate extends beyond the edges of said front and back paper plates whereby the edges of each of said panels are foam to generally prevent contact injuries to children handling said book.

4. The vehicle-shaped book of foam-based pages of claim 1 further comprising a binder extending across and connecting the rear edges of said central chassis page and each of said at least one body pages whereby said central chassis page and said at least one body page are secured in a book format, said pages being freely movable between a closed position aligned generally parallel with one another and an open position separated from one another.

5. The vehicle-shaped book of foam-based pages of claim 4 wherein said binder comprises a reinforced paper sheet which is connected to said rear edges of said central chassis page and each of said at least one body pages by an adhesive substance.

6. The vehicle-shaped book of foam-based pages of claim 1 wherein said lower chassis body is a generally rectangular box having an interior volume.

7. The vehicle-shaped book of foam-based pages of claim 1 wherein said front and back semi-rigid paper plates further comprise indicia printed thereon.

8. The vehicle-shaped book of foam-based pages of claim 1 further comprising motor means operatively connected to at least one of said front and rear wheels for propelling said vehicle-shaped book.

9. The vehicle-shaped book of foam-based pages of claim 1 further comprising a front bumper mounted on said lower chassis body.

10. The vehicle-shaped book of foam-based pages of claim 1 further comprising a page securement strap mounted on an outer one of said at least one body pages and which extends between and releasably connects said outer one of said at least one body pages and the opposite outer one of said at least one body to releasably secure said vehicle-shaped book in its closed position.

11. A vehicle-shaped book of foam-based pages comprising:
a center chassis page and at least one body page, each page being constructed of a panel of a semi-flexible foam material;
said center chassis page and at least one body page each being constructed as including a middle foam plate and front and back semi-rigid paper plates mounted on and sandwiching said middle foam plate;
said center chassis page and said at least one body page bound to adjacent pages thereof in a book format;
a lower chassis body on which said center chassis page is mounted on and extends upwards therefrom; and
front and rear ground-engaging wheels rotatably mounted on said center chassis page whereby said vehicle-shaped book is rollable on said front and rear ground-engaging wheels.

12. A vehicle-shaped book of foam-based pages comprising:
a center chassis page and at least one body page, each page being constructed of a panel of a semi-flexible foam material;
said center chassis page and said at least one body page bound in a book format with adjacent pages generally parallel with one another;
a lower chassis body on which said center chassis page is mounted on and extends upwards therefrom; and
at least two wheels rotatably mounted on said center chassis page whereby said vehicle-shaped book is rollable on said at least two wheels.
